(19) United States
(12) Patent Application Publication
(10) Pub. No.: US 2019/0086752 A1
(43) Pub. Date: Mar. 21, 2019

(54) ARRAY SUBSTRATE AND DISPLAY PANEL INCLUDING SAME

(71) Applicant: HKC Corporation Limited, Shenzhen City, Guangdong (CN)

(72) Inventor: Beizhou HUANG, Shenzhen City, Guangdong (CN)

(21) Appl. No.: 15/738,775

(22) PCT Filed: Oct. 20, 2017
(86) PCT No.: PCT/CN2017/107025

§ 371 Date: Dec. 21, 2017

(30) Foreign Application Priority Data
Sep. 19, 2017 (CN) 201710847372.1

(51) Int. Cl. G02F 1/1362; G02F 1/1368; G02F 1/1335

(52) U.S. Cl. CPC G02F 1/136286; G02F 1/1368; G09G 3/3648; G09G 2320/0242; G02F 1/133514

(57) ABSTRACT

An array substrate includes: a substrate having a display region and a wiring region; active switch, disposed on the substrate; a plurality of scanning lines and a plurality of data lines, disposed on the substrate, where the scanning lines are electrically connected to a control end of the active switch, and the data lines are electrically connected to an input end of the active switch; and a plurality of pixel units, disposed on the display region and electrically connected to an output end of the active switch, where: each of the pixel unit includes a first pixel and a second pixel, and the pixel unit includes a VA pixel and a polymer-stabilized VA pixel; and a pixel electrode of the VA pixel and a pixel electrode of the polymer-stabilized VA pixel are separately electrically coupled to the substrate.

### BACKGROUND

### Technical Field

This application relates to a pixel design method, and in particular, to an array substrate and a display panel including same.

### Related Art

A liquid crystal display (LCD) panel usually includes a color filter (CF) substrate, an active switch array substrate (thin film transistor array substrate, TFT Array Substrate), and a liquid crystal layer disposed between the two substrates. A working principle of the LCD is controlling rotation of liquid crystal molecules of the liquid crystal layer by applying a driving voltage to two glass substrates, so as to refract light from a backlight module to generate an image. According to different liquid crystal orientation manners, LCD panels in the current mainstream market may be classified into the following types: a vertical alignment (VA) type, a twisted nematic (TN) or a super twisted nematic (STN) type, an in-plane switching (IPS) type, and a fringe field switching (FFS) type.

LCDs of a VA mode include, for example, a patterned vertical alignment (PVA) LCD or a multi-domain vertical alignment (MVA) LCD. The PVA LCD achieves a wide-angle view by using a fringe field effect and a compensation plate. In the MVA LCD, one pixel is divided into a plurality of domains, and liquid crystal molecules in different domains are tilted toward different directions by using a protrusion or a particular pattern structure, to achieve a wide-angle view and improve penetrate.

Moreover, LCDs are most widely used displays in the market currently, and in particular, are widely used in liquid crystal televisions. As resolution is gradually improved, a size of a pixel is increasingly small, and an opening rate is also increasingly low. Because when being viewed, a product having a large size has a relatively broad range of visible angles, when the product is viewed from a large viewing angle, a color shift phenomenon may occur.

Formerly, to resolve a large-viewing-angle color shift problem, in terms of design, there are a main pixel and a sub pixel, and 4 domains are changed into 8 domains by pulling down a voltage of the sub pixel, to improve a viewing angle. In such design, usually, three or more active switches are used to perform control.

However, in such design, as resolution is increasingly high, a pixel is increasingly small, a space occupied by active switches is increasingly large, and consequently, an opening rate is increasingly low. Therefore, to obtain a high opening rate, designing a product having a large size and high resolution to have 4 domains is gradually resumed, and then, a viewing angle is improved by using an electrical algorithm. However, such an improvement method may cause some display problems.

### SUMMARY

To resolve the foregoing technical problem, an objective of this application is to provide a pixel design method, and in particular, an array substrate and a display panel including same, so as to not only effectively resolve a color shift problem, but also effectively improve a viewing angle of a product having a large size and high resolution, thereby increasing penetrate of the product having a large size and high resolution.

The objective of this application is achieved and the technical problem of this application is resolved by using the following technical solution. An array substrate is provided according to this application, comprising: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; and a plurality of pixel units, disposed on the display region and electrically connected to an output end of the active switch, where: each of the pixel unit comprises a first pixel and a second pixel, and the pixel unit comprises a VA pixel and a polymer-stabilized VA pixel; and a pixel electrode of the VA pixel and a pixel electrode of the polymer-stabilized VA pixel are separately electrically coupled to the substrate.

The objective of this application may further be achieved and the technical problem of this application may further be resolved by taking the following technical measures.

Another objective of this application is to provide an array substrate, comprising: a substrate, having a display region and a wiring region; at least one active switch, disposed on the substrate; a plurality of scanning lines and a plurality of data lines, disposed on the substrate, where the scanning lines are electrically connected to a control end of the active switch, and the data lines are electrically connected to an input end of the active switch; and a plurality of pixel units, disposed on the display region and electrically connected to an output end of the active switch, where: each of the pixel unit comprises a first pixel and a second pixel, and the pixel unit comprises a VA pixel and a polymer-stabilized VA pixel; a pixel electrode of the VA pixel and a pixel electrode of the polymer-stabilized VA pixel are separately electrically connected to the substrate; the VA pixel and the polymer-stabilized VA pixel are arranged in an array form; and the VA pixel and the polymer-stabilized VA pixel are rectangular.

Still another objective of this application is to provide a display panel, comprising: an opposite substrate, disposed opposite to an array substrate; a CF, comprising a plurality of color resists, and the array substrate, where the CF is disposed on the opposite substrate or the array substrate.

In an embodiment of this application, among the plurality of pixel units, each of the pixel unit comprises a first pixel and a second pixel.

In an embodiment of this application, the first pixel is the VA pixel, and the second pixel is the polymer-stabilized VA pixel.

In an embodiment of this application, the first pixel is the polymer-stabilized VA pixel, and the second pixel is the VA pixel.

In an embodiment of this application, the first pixel is a main pixel, and the second pixel is a sub pixel; or the first pixel is a sub pixel, and the second pixel is a main pixel.

In an embodiment of this application, a data line electrically coupled to the polymer-stabilized VA pixel and a data line electrically coupled to the VA pixel have different neighboring electrical properties.

In an embodiment of this application, a scanning line electrically coupled to the polymer-stabilized VA pixel and a scanning line electrically coupled to the VA pixel have different neighboring electrical properties.

In an embodiment of this application, the VA pixel and the polymer-stabilized VA pixel are disposed in a spaced manner or in a staggered manner.

This application may resolve a color shift problem of an LCD panel and increase an opening rate of a pixel and penetrate.

### BRIEF DESCRIPTION OF THE DRAWINGS

FIG. 1a is a schematic design diagram of an exemplary 8-domain pixel;

FIG. 1b is a diagram of an exemplary liquid crystal pixel circuit for resolving a color shift problem;

FIG. 2 is a schematic diagram of arrangement including a VA pixel and a polymer-stabilized VA according to an embodiment of this application;

FIG. 2a is a schematic diagram of arrangement including a VA pixel and a polymer-stabilized VA according to another embodiment of this application;

FIG. 3a is a schematic waveform diagram of a scanning line according to an embodiment of this application;

FIG. 3b is a schematic diagram of control and driving including a VA pixel and a polymer-stabilized VA according to an embodiment of this application;

FIG. 4a is a schematic waveform diagram of a scanning line according to another embodiment of this application;

FIG. 4b is a schematic diagram of control and driving including a VA pixel and a polymer-stabilized VA according to another embodiment of this application;

FIG. 5 is a schematic diagram of pixel arrangement according to an embodiment of this application;

FIG. 6 is a schematic diagram of pixel arrangement according to another embodiment of this application;

FIG. 7 is a schematic diagram of pixel arrangement according to still another embodiment of this application;

FIG. 8 is a schematic diagram of pixel arrangement according to yet another embodiment of this application;

FIG. 9 is a schematic diagram of pixel arrangement according to yet still another embodiment of this application; and

FIG. 10 is a block diagram of a display panel according to an embodiment of this application.

### DETAILED DESCRIPTION

The following embodiments are described with reference to the accompanying drawings, and are used to exemplify particular embodiments for implementation of this application. Terms about directions mentioned in this application, such as “on”, “below”, “front”, “back”, “left”, “right”, “in”, “out”, and “side face”, merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures and functions used in the this application for achieving the predetermined application objectives, specific implementations, structures, features, and functions of an array substrate and a display panel including same provided in this application are described below in detail with reference to the accompanying drawings and preferred embodiments.

A display panel in this application may be an LCD panel, including a switch array (thin film transistor, TFT) substrate, a CF substrate, and a liquid crystal layer formed between the two substrates, or an organic light-emitting diode (OLED) panel, or a quantum dots light-emitting diode (QLED) panel.

In an embodiment, the display panel in this application may be a curved-surface display panel.

In an embodiment, a switch array (TFT) and a CF in this application may be formed on a same substrate.

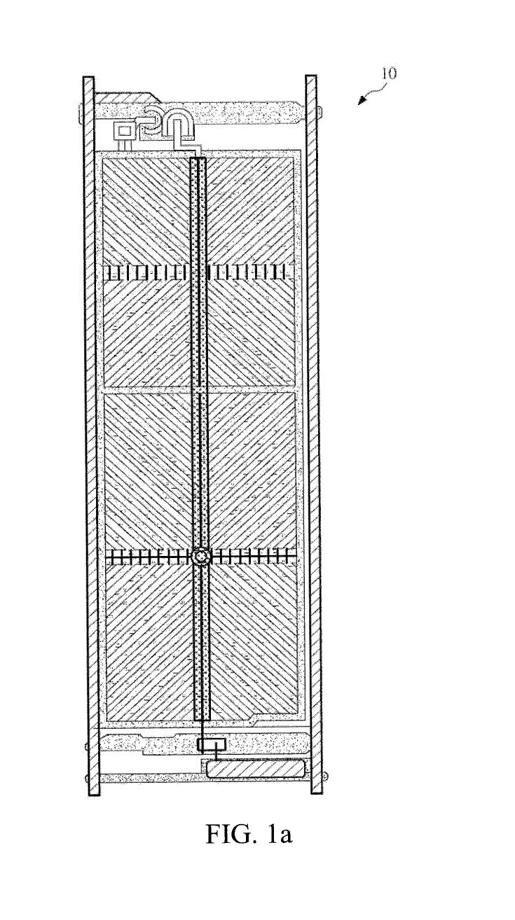

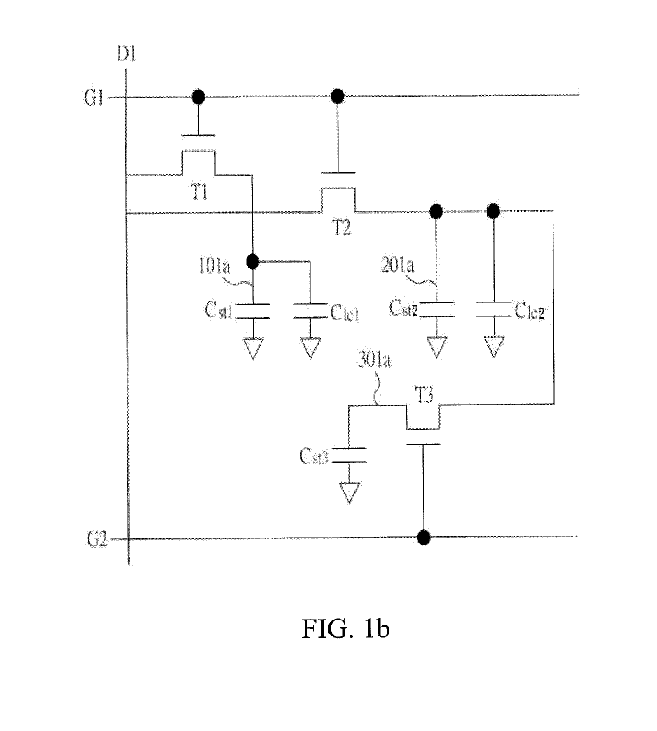

FIG. 1a is a schematic design diagram of an exemplary 8-domain pixel, and FIG. 1b is a diagram of an exemplary liquid crystal pixel circuit for resolving a color shift problem. In an LCD, performing charge sharing between a plurality of capacitors in a pixel is a technology derived for resolving a color shift problem. Referring to FIG. 1b, in the liquid crystal pixel circuit shown in FIG. 1b, a main pixel is controlled by a scanning line G1 to obtain data from a data line D1 by using a transistor T₁ and store the data into a storage capacitor Cₛₜ₁, and in addition to also being controlled by the scanning line G1 to obtain data from the data line D1 by using a transistor T₂ and store the data into a storage capacitor Cₛₜ₂, a sub pixel is further controlled by a scanning line G2 to enable, by using a transistor T₃, the storage capacitor Cₛₜ₂ and a storage capacitor Cₛₜ₃ to perform charge sharing. By means of such architecture, the liquid crystal pixel circuit shown in FIG. 1 can properly control a proportion of stored voltages of the storage capacitor Cₛₜ₁ and the storage capacitor Cₛₜ₂, so as to allow liquid crystal capacitors C_{1c1} and C_{1c2} to be driven by a default voltage, thereby eliminating a color shift problem during display. However, with updating of technologies, LCDs are also improved in terms of either resolution or a screen refresh rate. In this case, not matter whether more data in a pixel circuit needs to be updated within a same time because of higher resolution, or an original amount of data in a pixel circuit needs to be updated within a shorter time because of a higher screen refresh rate, or more data in a pixel circuit needs to be updated within a shorter time when both resolution and a screen refresh rate are higher, for each of the pixel circuit, a usable charging time for storing data on the data line D1 into the storage capacitors Cₛₜ₁ and Cₛₜ₂ would be reduced. Once a usable charging time for a pixel circuit is reduced, the storage capacitors Cₛₜ₁ and Cₛₜ₂ possibly cannot be fully charged, and consequently, stored voltages of the storage capacitors Cₛₜ₁ and Cₛₜ₂ are unlikely to achieve a same level. Once the stored voltages of the storage capacitors Cₛₜ₁ and Cₛₜ₂ are different, after the storage capacitor Cₛₜ₂ and the storage capacitor Cₛₜ₃ perform charge sharing, a ratio between a voltage maintained by the storage capacitor Cₛₜ₂ and a voltage maintained by the storage capacitor Cₛₜ₁ cannot achieve an originally set proportion. Therefore, the color shift problem originally to be eliminated occurs in a display process again.

Referring to FIG. 1a, a pixel structure 10 resolving a large-viewing-angle color shift problem, in terms of design, includes a main pixel and a sub pixel, and 4 domains are changed into 8 domains by pulling down a voltage of the sub pixel, to improve a viewing angle.

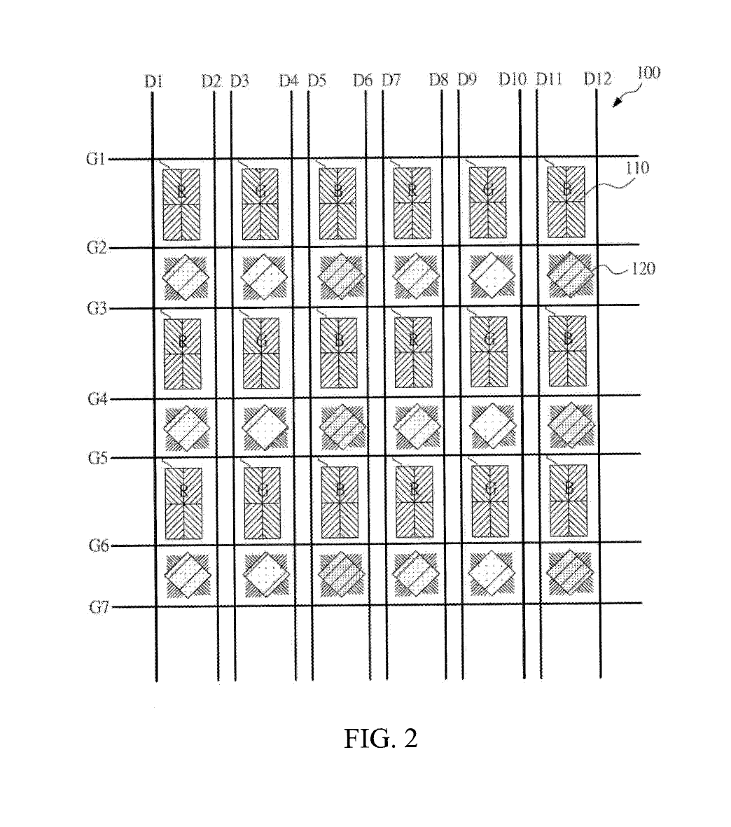

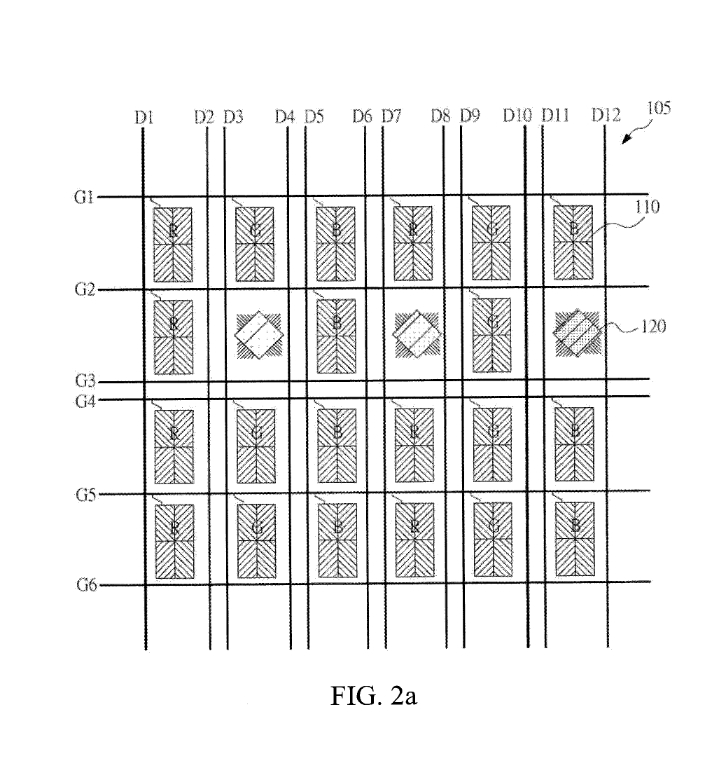

FIG. 2 is a schematic diagram of arrangement including a VA pixel and a polymer-stabilized VA according to an embodiment of this application. Referring to FIG. 1b and FIG. 2, a pixel structure unit 100, includes: scanning lines G1 to G7, disposed to provide scanning signals; data lines D1 to D12, disposed to provide data signals, where the data lines D1 to D12 and the scanning lines G1 to G7 define at least one pixel domain 110 or 120; switch transistors T1, T2, and T3, electrically connected to the scanning lines G1 and G2 and the data line D1, and transmitting the data signals under the control of the scanning signals within a first time period, where the first time period corresponds to a data loading mode of the pixel structure unit 100; and storage capacitors Cₛₜ₁, Cₛₜ₂, and Cₛₜ₃, having first connection ends 101a, 201a, and 301a and second connection ends, where the first connection ends 101a, 201a, and 301a are electrically connected to the switch transistors T1, T2, and T3, and are disposed to receive the data signals within the first time period, where the pixel domain 110 or 120 may be a VA pixel 110 or a polymer-stabilized VA pixel 120.

In an embodiment, the scanning lines G1 to G7 control voltages values of the VA pixel 110 and the polymer-stabilized VA pixel 120.

In an embodiment, indium tin oxide of the VA pixel 110 is not connected to indium tin oxide of the polymer-stabilized VA pixel 120, to prevent chaotic liquid crystal falling directions.

FIG. 2a is a schematic diagram of arrangement including a VA pixel and a polymer-stabilized VA according to another embodiment of this application. Referring to FIG. 2a, an array substrate 105 includes a substrate, having a display region and a wiring region; at least one active switch (not shown in the figure), disposed on the substrate; a plurality of scanning lines G1 to G6 and a plurality of data lines D1 to D12, disposed on the substrate, where the scanning lines G1 to G6 are electrically connected to a control end of the active switch, and the data lines D1 to D12 are electrically connected to an input end of the active switch; and a plurality of pixel units 110 and 120, disposed on the display region and electrically connected to an output end of the active switch, where: each of the pixel unit includes a first pixel and a second pixel, and the pixel unit includes a VA pixel 110 and a polymer-stabilized VA pixel 120; and a pixel electrode of the VA pixel 110 and a pixel electrode of the polymer-stabilized VA pixel 120 are separately electrically coupled to the substrate.

Referring to FIG. 2a, an array substrate 105 includes a substrate, having a display region and a wiring region; a plurality of pixel units 110 and 120, disposed on the display region and respectively electrically coupled to corresponding data lines D1 to D12 and scanning lines G1 to G6, where each of the pixel unit includes at least one of a VA pixel 110 and a polymer-stabilized VA pixel 120.

Referring to FIG. 2a, in an embodiment, among the plurality of pixel units 110 and 120, each of the pixel unit includes a first pixel and a second pixel.

Referring to FIG. 2a, in an embodiment, the first pixel is the VA pixel 110, and the second pixel is the polymer-stabilized VA pixel 120, but their arrangement is not limited to this manner.

Referring to FIG. 2a, in an embodiment, the first pixel is the polymer-stabilized VA pixel 120, and the second pixel is the VA pixel 110, but their arrangement is not limited to this manner.

Referring to FIG. 2a, in an embodiment, the first pixel 110 is a main pixel, and the second pixel 120 is a sub pixel. Alternatively, the first pixel 110 is a sub pixel, and the second pixel 120 is a main pixel.

Referring to FIG. 2a, in an embodiment, the VA pixel 110 and the polymer-stabilized VA pixel 120 are disposed in a spaced manner or in a staggered manner.

Referring to FIG. 2a, in an embodiment, an array substrate 105 includes a substrate, having a display region and a wiring region; at least one active switch (not shown in the figure), disposed on the substrate; a plurality of scanning lines G1 to G6 and a plurality of data lines D1 to D12, disposed on the substrate, where the scanning lines G1 to G6 are electrically connected to a control end of the active switch, and the data lines D1 to D12 are electrically connected to an input end of the active switch; and a plurality of pixel units 110 and 120, disposed on the display region and electrically connected to an output end of the active switch, where: each of the pixel unit includes a first pixel and a second pixel, and the pixel unit includes a VA pixel 110 and a polymer-stabilized VA pixel 120; a pixel electrode of the VA pixel 110 and a pixel electrode of the polymer-stabilized VA pixel 120 are separately electrically connected to the substrate; the first pixel is the VA pixel 110, and the second pixel is the polymer-stabilized VA pixel 120, or the first pixel is polymer-stabilized VA pixel 120, and the second pixel is VA pixel 110; the VA pixel 110 and the polymer-stabilized VA pixel 120 are arranged in an array form; the VA pixel 110 and the polymer-stabilized VA pixel 120 rectangular; and the VA pixel 110 and the polymer-stabilized VA pixel 120 are disposed in a spaced and intersecting manner.

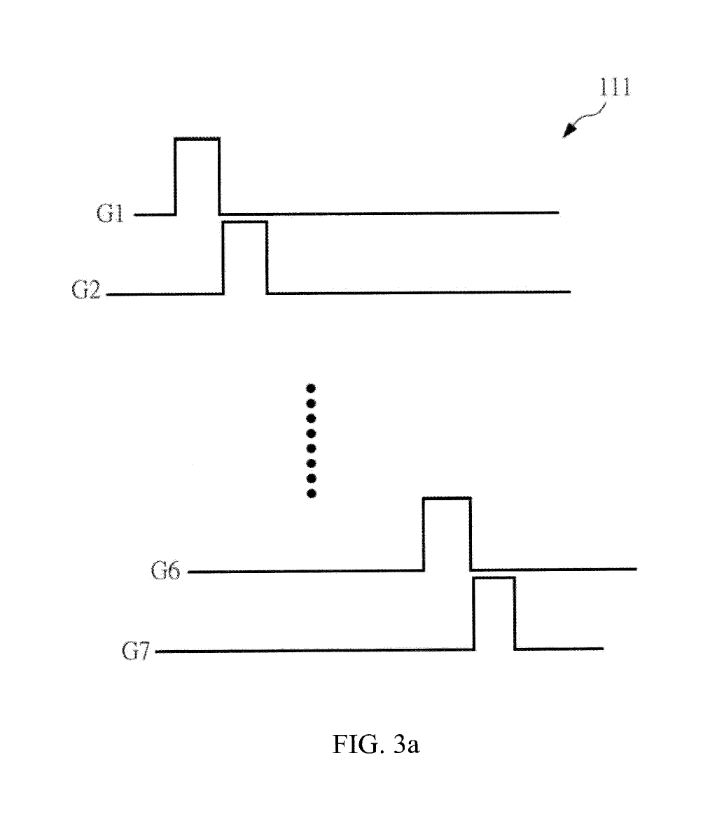

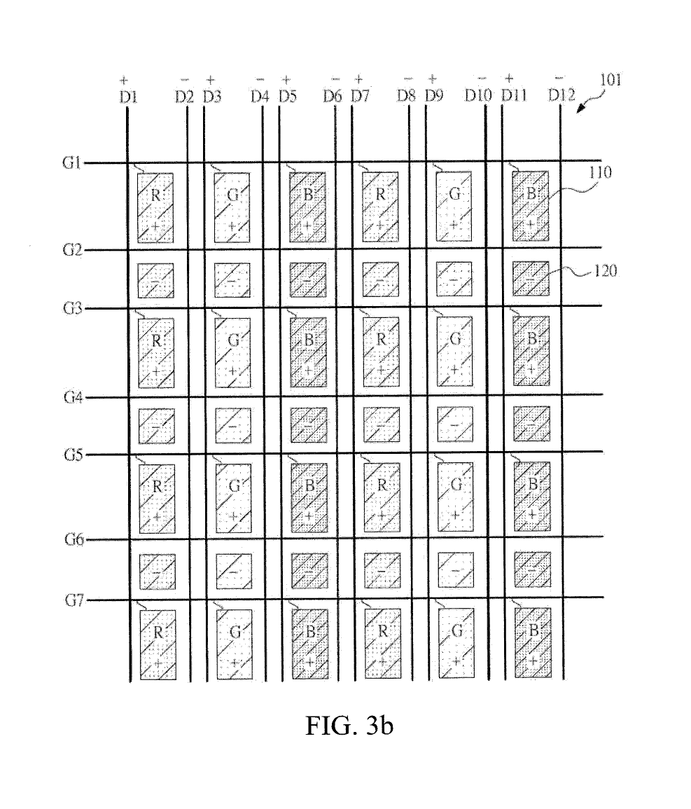

FIG. 3a is a schematic waveform diagram of a scanning line according to an embodiment of this application, and FIG. 3b is a schematic diagram of control and driving including a VA pixel and a polymer-stabilized VA according to an embodiment of this application. Referring to FIG. 3b, an array substrate 101 includes a substrate, having a display region and a wiring region; a plurality of pixel units 110 and 120, disposed on the display region and respectively electrically coupled to corresponding data lines D1 to D12 and scanning lines G1 to G7, where each of the pixel unit includes at least one of a VA pixel 110 and a polymer-stabilized VA pixel 120.

Referring to FIG. 3b, in an embodiment, among the plurality of pixel units 110 and 120, each of the pixel unit includes a first pixel and a second pixel.

Referring to FIG. 3b, in an embodiment, the first pixel is the VA pixel 110, and the second pixel is the polymer-stabilized VA pixel 120.

Referring to FIG. 3b, in an embodiment, the first pixel 110 is a main pixel, and the second pixel 120 is a sub pixel.

Referring to FIG. 3b, in an embodiment, scanning lines G2, G4, and G6 electrically coupled to the polymer-stabilized VA pixel 120 and scanning lines G1, G3, G5, and G7 electrically coupled to the VA pixel 110 have different neighboring electrical properties.

Referring to FIG. 3a and FIG. 3b, in an embodiment, a waveform 111 of the scanning lines G1 to G7 of the VA pixel 110 and the polymer-stabilized VA pixel 120 is provided.

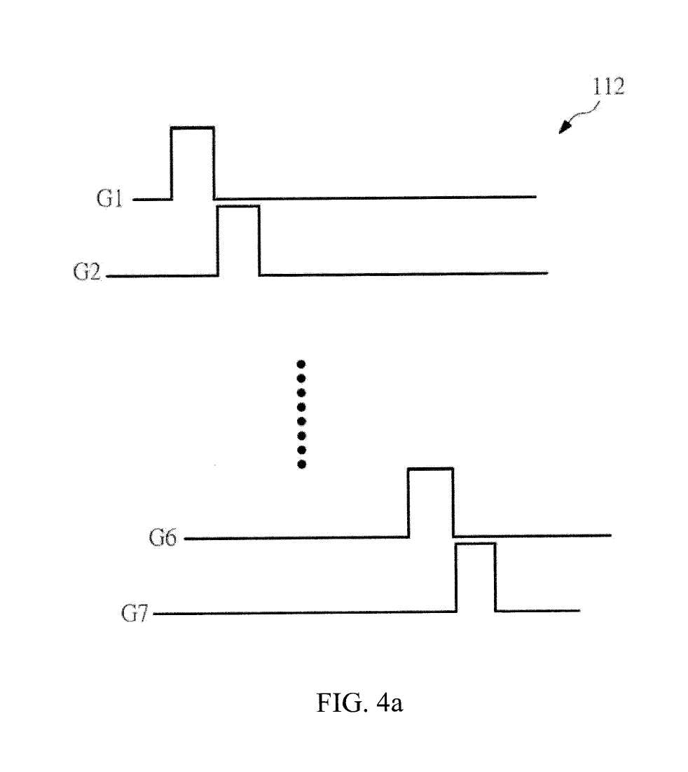

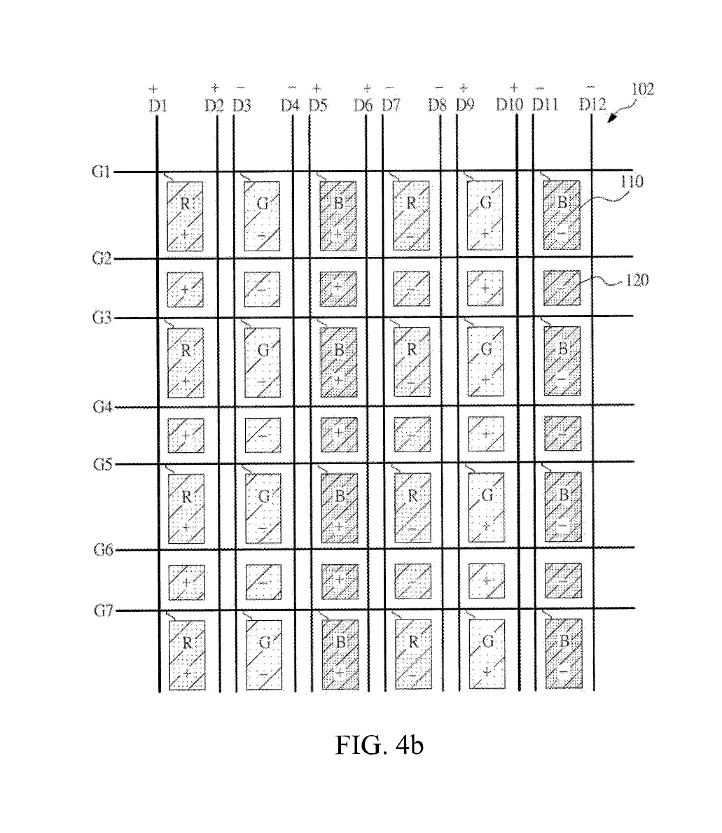

FIG. 4a is a schematic waveform diagram of a scanning line according to another embodiment of this application, and FIG. 4b is a schematic diagram of control and driving including a VA pixel and a polymer-stabilized VA according to another embodiment of this application. Referring to FIG. 4b, an array substrate 102 includes a substrate, having a display region and a wiring region; a plurality of pixel units 110 and 120, disposed on the display region and respectively electrically coupled to corresponding data lines D1 to D12 and scanning lines G1 to G7, where each of the pixel unit includes at least one of a VA pixel 110 and a polymer-stabilized VA pixel 120.

Referring to FIG. 4b, in an embodiment, among the plurality of pixel units 110 and 120, each of the pixel unit includes a first pixel and a second pixel.

Referring to FIG. 4b, in an embodiment, the first pixel is the VA pixel 110, and the second pixel is the polymer-stabilized VA pixel 120.

Referring to FIG. 4b, in an embodiment, the first pixel 110 is a main pixel, and the second pixel 120 is a sub pixel.

Referring to FIG. 3b, in an embodiment, data lines D1, D2, D5, D6, D9, and

D10 electrically coupled to the polymer-stabilized VA pixel 120 and data lines D3, D4, D7, D8, D11, and D12 electrically coupled to the VA pixel 110 have different neighboring electrical properties.

Referring to FIG. 4a and FIG. 4b, in an embodiment, a waveform 112 of the scanning lines G1 to G7 of the VA pixel 110 and the polymer-stabilized VA pixel 120 is provided.

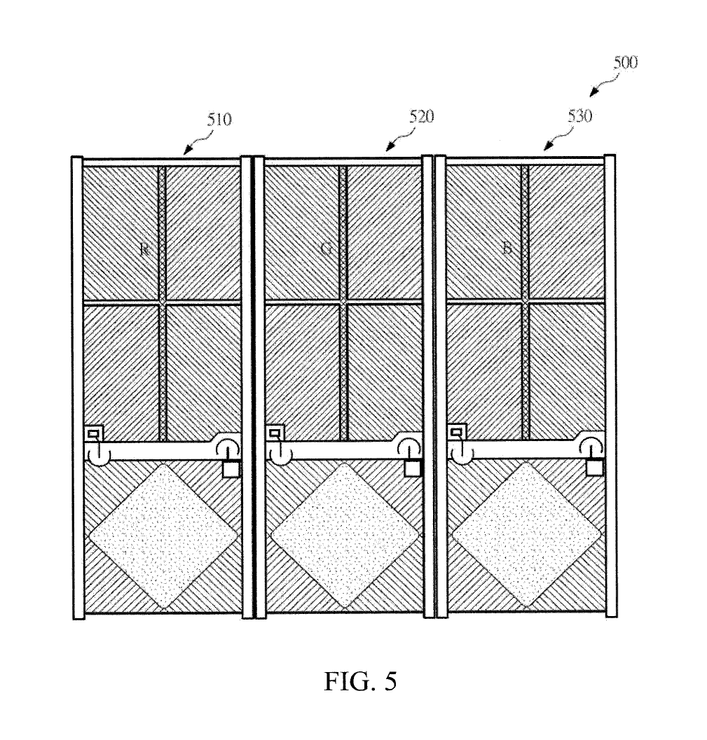

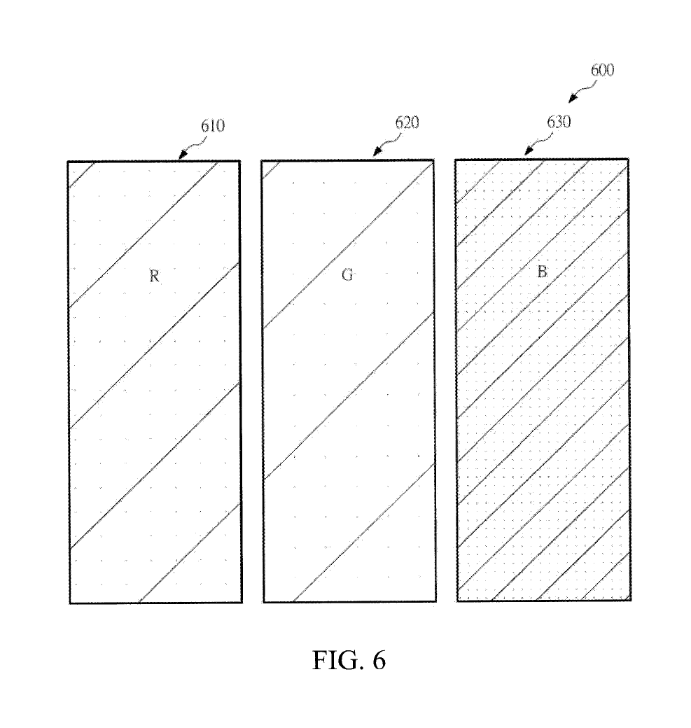

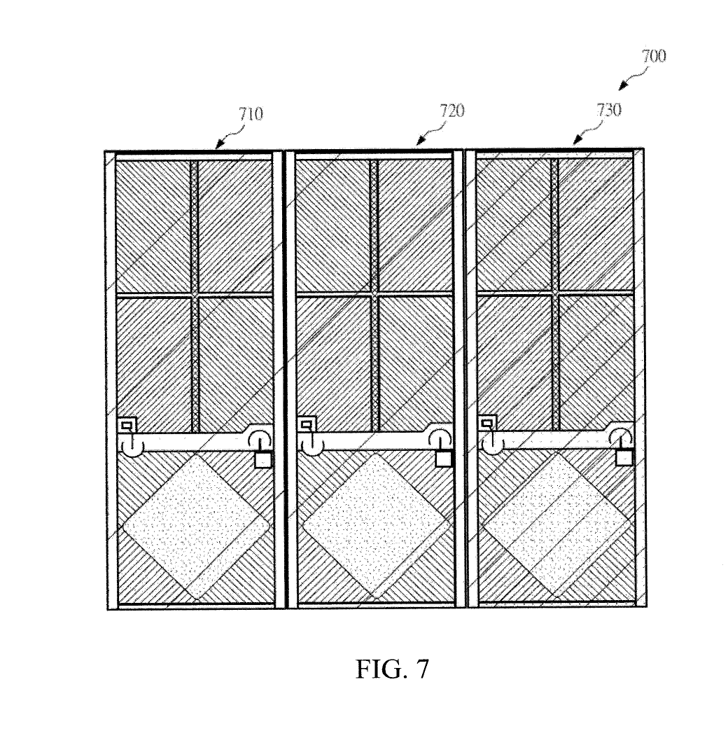

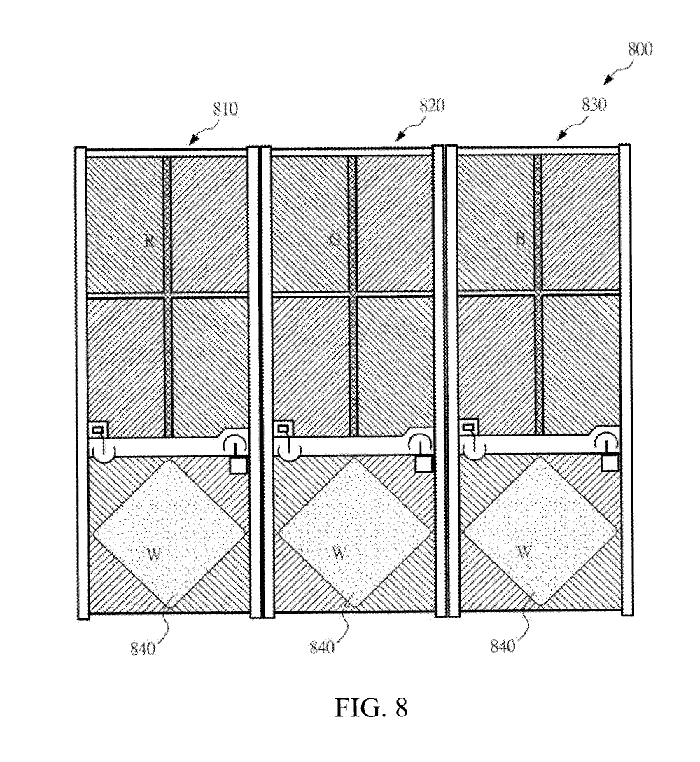

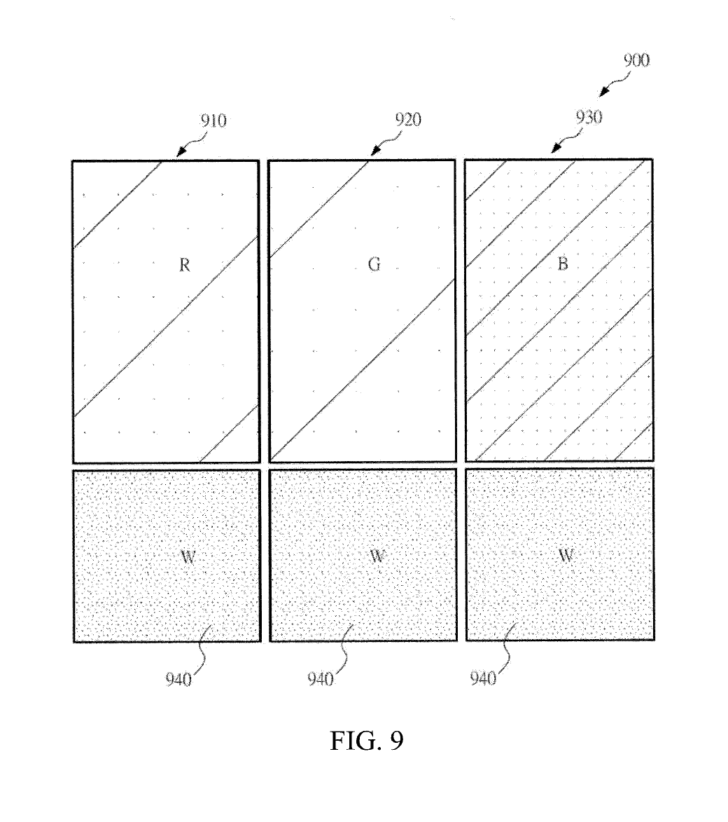

FIG. 5 is a schematic diagram of pixel arrangement according to an embodiment of this application, FIG. 6 is a schematic diagram of pixel arrangement according to another embodiment of this application, FIG. 7 is a schematic diagram of pixel arrangement according to still another embodiment of this application, FIG. 8 is a schematic diagram of pixel arrangement according to yet another embodiment of this application, and FIG. 9 is a schematic diagram of pixel arrangement according to yet still another embodiment of this application. Referring to FIG. 5, in an embodiment of this application a display panel 500 includes a substrate (not shown in the figure); a CF, including a plurality of color resists (a red color resist 510, a green color resist 520, and a blue color resist 530), and the array substrate 101 or 102, where the color resists are disposed on the substrate or the array substrate 101 or 102.

Referring to FIG. 2 and FIG. 5, in an embodiment, the color resists include a first color resist (the red color resist 510), a second color resist (the green color resist 520), and a third color resist (the blue color resist 530), where the color resists and the pixel unit 110 are disposed in a one-to-one corresponding manner.

Referring to FIG. 6, in an embodiment of this application, a CF 600 including a VA pixel and a polymer-stabilized VA pixel includes: a red photoresist layer 610, a green photoresist layer 620, and a blue photoresist layer 630.

Referring to FIG. 7, in an embodiment of this application, an array substrate 700 including a VA pixel and a polymer-stabilized VA pixel applicable to a CF on the substrate includes: a red array substrate 710, a green array substrate 720, and a blue array substrate 730.

Referring to FIG. 8, in an embodiment of this application a display panel 800 includes a substrate (not shown in the figure); a CF, including a plurality of color resists (a red color resist 810, a green color resist 820, a blue color resist 830, and a white color resist 840), and the array substrate 101 or 102, where the color resists are disposed on the substrate or the array substrate 101 or 102.

Referring to FIG. 2 and FIG. 8, in an embodiment, the color resists include a first color resist (the red color resist 810), a second color resist (the green color resist 820), a third color resist (the blue color resist 830), and a fourth color resist (the white color resist 840), where the fourth color resist (the white color resist 840) and the second pixel domain 120 of the pixel unit are disposed in a corresponding manner, and the first color resist (the red color resist 810), the second color resist (the green color resist 820), and the third color resist (the blue color resist 830), and the first pixel domain 110 are disposed in a corresponding manner.

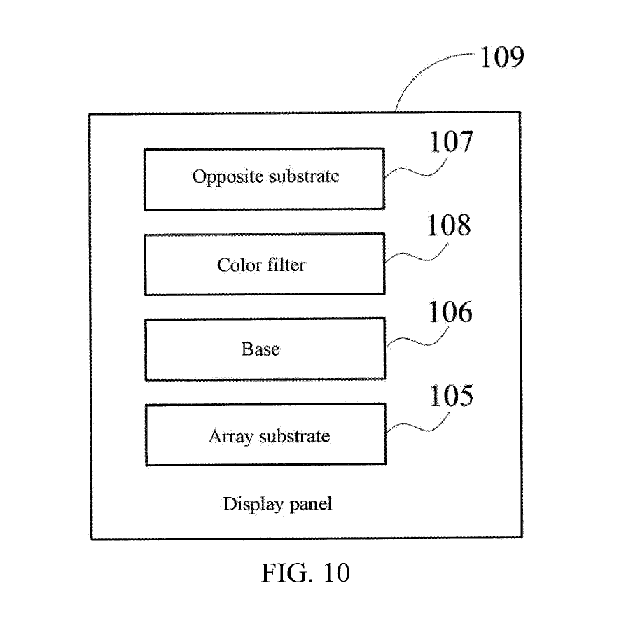

FIG. 10 is a block diagram of a display panel according to an embodiment of this application. Referring to FIG. 10, in an embodiment, a display panel 109 includes: an array substrate 105, including: a substrate 106, having a display region and a wiring region; at least one active switch (not shown in the figure), disposed on the substrate 106; a plurality of scanning lines G1 to G6 and a plurality of data lines D1 to D12, disposed on the substrate 106, where the scanning lines G1 to G6 are electrically connected to a control end of the active switch, and the data lines D1 to D12 are electrically connected to an input end of the active switch; and a plurality of pixel units 110 and 120, configured on the display region and electrically connected to an output end of the active switch, where: each of the pixel unit includes a first pixel and a second pixel, and the pixel unit includes a VA pixel 110 and a polymer-stabilized VA pixel 120; and a pixel electrode of the VA pixel 110 and a pixel electrode of the polymer-stabilized VA pixel 120 are separately electrically coupled to the substrate; an opposite substrate 107, disposed opposite to the array substrate 105; and a CF 108, including a plurality of color resists, where the CF 108 is configured on the opposite substrate 107 or the array substrate 105.

Referring to FIG. 9, in an embodiment of this application, a CF 900 including a VA pixel and a polymer-stabilized VA pixel and applicable to red, green, blue, and white includes: a red photoresist layer 910, a green photoresist layer 920, a blue photoresist layer 930, and a white photoresist layer 940.

This application may resolve a large-viewing-angle color shift problem of a display panel and improve product competitiveness and consumer satisfaction.

The wordings such as “in some embodiments” and “in various embodiments” are repeatedly used. The wordings usually refer to different embodiments, but they may alternatively refer to a same embodiment. The words, such as “comprise”, “have”, and “include”, are synonyms, unless other meanings are indicated in the context thereof.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. An array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixel units, disposed on the display region and electrically connected to an output end of the active switch, wherein:
each of the pixel unit comprises a first pixel and a second pixel, and the pixel unit comprises a vertical alignment (VA) pixel and a polymer-stabilized VA pixel; and a pixel electrode of the VA pixel and a pixel electrode of the polymer-stabilized VA pixel are separately electrically coupled to the substrate.

2. The array substrate according to claim 1, wherein the first pixel is the VA pixel.

3. The array substrate according to claim 1, wherein the second pixel is the polymer-stabilized VA pixel.

4. The array substrate according to claim 1, wherein the first pixel is the polymer-stabilized VA pixel.

5. The array substrate according to claim 1, wherein the second pixel is the VA pixel.

6. The array substrate according to claim 1, wherein the first pixel is a main pixel.

7. The array substrate according to claim 1, wherein the second pixel is a sub pixel.

8. The array substrate according to claim 1, wherein the first pixel is a sub pixel.

9. The array substrate according to claim 1, wherein the second pixel is a main pixel.

10. The array substrate according to claim 1, wherein a data line electrically coupled to the polymer-stabilized VA pixel and a data line electrically coupled to the VA pixel have different neighboring electrical properties.

11. The array substrate according to claim 1, wherein a scanning line electrically coupled to the polymer-stabilized VA pixel and a scanning line electrically coupled to the VA pixel have different neighboring electrical properties.

12. The array substrate according to claim 1, wherein the VA pixel and the polymer-stabilized VA pixel are disposed in a spaced manner.

13. The array substrate according to claim 1, wherein the VA pixel and the polymer-stabilized VA pixel are disposed in a staggered manner.

14. The array substrate according to claim 1, wherein the VA pixel and the polymer-stabilized VA pixel are arranged in an array form.

15. The array substrate according to claim 1, wherein the VA pixel and the polymer-stabilized VA pixel are rectangular.

16. An array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixel units, disposed on the display region and electrically connected to an output end of the active switch, wherein:
each of the pixel unit comprises a first pixel and a second pixel, and the pixel unit comprises a vertical alignment (VA) pixel and at least one polymer-stabilized VA pixel; a pixel electrode of the VA pixel and a pixel electrode of the polymer-stabilized VA pixel are not electrically connected; the VA pixel and the polymer-stabilized VA pixel are arranged in an array form; the VA pixel and the polymer-stabilized VA pixel are rectangular; and the VA pixel and the polymer-stabilized VA pixel are disposed in a spaced and intersecting manner.

17. A display panel, comprising:
an array substrate, comprising:
a substrate, having a display region and a wiring region;
at least one active switch, disposed on the substrate;
a plurality of scanning lines and a plurality of data lines, disposed on the substrate, wherein the scanning lines are electrically connected to a control end of the active switch, and the data lines are electrically connected to an input end of the active switch; and
a plurality of pixel units, disposed on the display region and electrically connected to an output end of the active switch, wherein:
each of the pixel unit comprises a first pixel and a second pixel, and the pixel unit comprises a vertical alignment (VA) pixel and a polymer-stabilized VA pixel; and a pixel electrode of the VA pixel and a pixel electrode of the polymer-stabilized VA pixel are separately electrically coupled to the substrate;
an opposite substrate, disposed opposite to the array substrate; and
a color filter (CF), comprising a plurality of color resists, wherein
the CF is disposed on the opposite substrate or the array substrate.

18. The display panel according to claim 17, wherein the first pixel is the VA pixel, and the second pixel is the polymer-stabilized VA pixel.

19. The display panel according to claim 17, wherein the first pixel is the polymer-stabilized VA pixel, and the second pixel is the VA pixel.

20. The display panel according to claim 17, wherein the VA pixel and the polymer-stabilized VA pixel are disposed in a spaced and intersecting manner.
